(19) United States
(12) Patent Application Publication
(10) Pub. No.: US 2025/0369863 A1
(43) Pub. Date: Dec. 4, 2025

(54) METHOD FOR DETERMINING A STATUS OF A CO-CULTURE

(71) Applicant: Universiteit Antwerpen, Antwerpen (BE)

(72) Inventors: Maxim LE COMPTE, Wilrijk (BE); Christophe DEBEN, Wilrijk (BE); Edgar CARDENAS, Antwerpen (BE); Abraham LIN, Wilrijk (BE)

(73) Assignee: Universiteit Antwerpen, Antwerpen (BE)

(21) Appl. No.: 18/876,276

(22) PCT Filed: Jun. 29, 2023
(86) PCT No.: PCT/EP2023/067797

§ 371 Date: Dec. 18, 2024

(30) Foreign Application Priority Data
Jun. 29, 2022 (EP) 22181922.0

(51) Int. Cl. G01N 15/1433; G01N 15/10; G01N 15/14

(52) U.S. Cl. CPC G01N 15/1433; G01N 2015/1006; G01N 2015/1027; G01N 2015/1486; G01N 2015/1493; G01N 2500/10

(57) ABSTRACT

Provided is a method for determining a status of a sample comprising a co-culture comprising a target cellular object. TCO (520), and one or more stroma-forming cell types. SCT (510, a to b), wherein: the TCO (520) has been labelled with a fluorescent live-cell marker having a first emission/excitation profile, and the SCT (510, a to b) has been labelled with a fluorescent live-cell marker having a second emission/excitation profile different from the first emission/excitation profile, the method comprising the steps: capturing, during an acquisition event using a microscope, a dataset comprising: a first fluorescent image from the fluorescent live-cell marker having the first emission/excitation profile, and a second fluorescent image from the fluorescent live-cell marker having the second emission/excitation profile, and wherein: at least one dataset is captured, for each dataset, a stroma (512) is identified for the TCO (520), wherein: a stroma (512) comprises at least one cluster (514, a to d): a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells, wherein the status of the sample is determined from at least one parameter of the stroma (512).

### FIELD OF THE INVENTION

The present invention is in a field of determining a status of co-culture of cellular objects.

### BACKGROUND TO THE INVENTION

Cancer is a complex disease in which the tumor microenvironment (e.g. organoid, fibroblasts and immune cells) crucially impacts therapy responses. To date, in order to study modulatory effects of fibroblasts and/or immune modulatory effects of an anti-cancer therapeutic, expensive and time-consuming mouse models are used. Moreover, the lack of standardization (due to the inter-mouse variation), endpoint measurements and low-throughput screening potential hampers the development of novel therapeutic options. Therefore, there is an unmet need to develop an in vitro method that is able to monitor/quantify the modulatory effects of fibroblasts and 2) immune modulatory effects of a therapeutic in a standardized and cost-effective high throughout setting.

### SUMMARY OF THE INVENTION

Provided herein is a method for determining a status of a sample comprising a co-culture comprising a target cellular object, TCO (520), and one or more stroma-forming cell types, SCT (510, a to b), wherein:
the TCO (520) has been labelled with a fluorescent live-cell marker having a first emission/excitation profile, and
the SCT (510, a to b) has been labelled with a fluorescent live-cell marker having a second emission/excitation profile different from the first emission/excitation profile, the method comprising the steps:
capturing, during an acquisition event using a microscope, a dataset comprising:
   a first fluorescent image from the fluorescent live-cell marker having the first emission/excitation profile, and
   a second fluorescent image from the fluorescent live-cell marker having the second emission/excitation profile, and
wherein:
   at least one dataset is captured,
   for each dataset, a stroma (512) is identified for the TCO (520), wherein:
      a stroma (512) comprises at least one cluster (514, a to d);
      a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells,
the status of the sample is determined from:
   at least one parameter of the stroma (512), wherein at least one parameter of the stroma (512) comprises one or more of:
      stroma size, stroma size ratio, stroma density, stroma-free SCT velocity, contractility (Table 1 (Parameters 1 to 5)),
and
   a presence or absence of an identified stroma, and/or
   a value(s) of the at least one parameter of the stroma of the identified stroma, and/or
   a comparison of the at least one parameter of the stroma of the identified stroma with a comparable reference, and/or
   an evolution of the at least one parameter of the stroma over time of the identified stroma.

Further provided herein is a method for determining a status of a sample comprising a co-culture comprising a target cellular object, TCO (520), and one or more stroma-forming cell types, SCT (510, a to b), wherein:
the TCO (520) has been labelled with a fluorescent live-cell marker having a first emission/excitation profile, and
the SCT (510, a to b) has been labelled with a fluorescent live-cell marker having a second emission/excitation profile different from the first emission/excitation profile, comprising the steps:
capturing, during an acquisition event using a microscope, a dataset comprising:
   a first fluorescent image from the fluorescent live-cell marker having the first emission/excitation profile, and
   a second fluorescent image from the fluorescent live-cell marker having the second emission/excitation profile, and
wherein:
   at least one dataset is captured,
   for each dataset, a stroma (512) is identified for the TCO (520), wherein:
      a stroma (512) comprises at least one cluster (514, a to d);
      a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells,
   wherein the status of the sample is determined from at least one parameter of the stroma (512).

Further provided herein is a method for determining an effect of a potential active agent on a sample comprising a co-culture comprising a target cellular object, TCO (520), and one or more stroma-forming cell types, SCT (510, a to b), wherein:
the TCO (520) has been labelled with a fluorescent live-cell marker having a first emission/excitation profile, and
the stroma-forming cell types, SCT (510, a to b) has been labelled with a fluorescent live-cell marker having a second emission/excitation profile different from the first emission/excitation profile,
comprising the steps:
capturing, during an acquisition event using a microscope, a dataset comprising:
   a first fluorescent image from the fluorescent live-cell marker having the first emission/excitation profile, and
   a second fluorescent image from the fluorescent live-cell marker having the second emission/excitation profile, and
wherein
   a plurality of datasets is captured, of which at least one test dataset is captured for a sample contacted with the potential active agent and one at least one control dataset is captured for a sample not contacted with the potential active agent,
   for each test dataset and for each control dataset, a stroma (512) is identified for the TCO (520), wherein:
      the stroma (512) comprises at least one cluster (514, a to d);
      a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells,
   the status of the test sample and the status control sample is determined from at least one parameter of the respective stromas (512),
determining from a difference between the status of the test sample and the status control sample an effect of the potential active agent.

Further provided herein is a method for determining an effect of a potential active agent on a sample comprising a co-culture comprising a target cellular object, TCO (520), and one or more stroma-forming cell types, SCT (510, a to b), wherein:
the TCO (520) has been labelled with a fluorescent live-cell marker having a first emission/excitation profile, and
the stroma-forming cell types, SCT (510, a to b) has been labelled with a fluorescent live-cell marker having a second emission/excitation profile different from the first emission/excitation profile,
the method comprising the steps:
capturing, during an acquisition event using a microscope, a dataset comprising:
   a first fluorescent image from the fluorescent live-cell marker having the first emission/excitation profile, and
   a second fluorescent image from the fluorescent live-cell marker having the second emission/excitation profile, and
wherein
   a plurality of datasets is captured, of which at least one test dataset is captured for a sample contacted with the potential active agent and one at least one control dataset is captured for a sample not contacted with the potential active agent,
   for each test dataset and for each control dataset, a stroma (512) is identified for the TCO (520), wherein:
      the stroma (512) comprises at least one cluster (514, a to d);
      a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells,
   the status of the test sample and the status control sample is determined from at least one parameter of the respective stromas (512), wherein the at least one parameter of each stroma (512) comprises one or more of:
      stroma size, stroma size ratio, stroma density, stroma-free SCT velocity, contractility (Table 1 (Parameters 1 to 5)),
determining from a difference between the status of the test sample and the status control sample an effect of the potential active agent.

The at least one parameter of the stroma (512) may be defined in Table 1 (Parameters 1 to 5).

The status of the sample is further determined from at least one measurable parameter of Table 2 (Parameters 6 to 8).

The sample co-culture may further comprise a stroma-supporting cell type (SSCT) (530, a,b), different from the TCO (520) and SCT (510, a to b) cells, wherein:
the SSCT (530, a,b) has been labelled with a fluorescent live-cell marker having an SSCT emission/excitation profile different from the first and second emission/excitation profiles,
the dataset further comprises an SSCT fluorescent image (503) from the fluorescent live-cell marker having the SSCT emission/excitation profile,
wherein the status of the sample is further determined from at least one parameter of the SSCT of Table 3 (Parameters 9 to 12).

The sample co-culture may further comprise a stroma-supporting cell type (SSCT) (530, a,b), different from the TCO (520) and SCT (510, a to b) cells, wherein:
the SSCT (530, a,b) has been labelled with a fluorescent live-cell marker having an SSCT emission/excitation profile different from the first and second emission/excitation profiles,
the dataset further comprises an SSCT fluorescent image (503) from the fluorescent live-cell marker having the SSCT emission/excitation profile,
wherein the status of the sample is further determined from
   at least one parameter of the SSCT, wherein the at least one parameter of the SSCT comprises one or more of Parameter 9, Parameter 10, Parameter 11, Parameter 12 of Table 3,
   and
      a presence or absence of a SSCT, and/or
      a value(s) of the at least one parameter of the SSCT, and/or
      a comparison of the at least one parameter of the SSCT with a comparable reference, and/or
      an evolution of the at least one parameter of the SSCT over time.

The SSCT may be endothelial.

The sample co-culture may further comprise an immune cell type (ICT) (540, a to d), different from the TCO (520) and SCTs (510, a to b) cells, wherein:
the ICT (540, a to d) has been labelled with a fluorescent live-cell marker having an ICT emission/excitation profile different from the first and second emission/excitation profiles,
the dataset further comprises an ICT fluorescent image (503) from the fluorescent live-cell marker having the ICT emission/excitation profile,
wherein the status of the sample is further determined from at least one parameter of the ICT of Table 4 (Parameters 13 to 20).

The sample co-culture may further comprise an immune cell type (ICT) (540, a to d), different from the TCO (520) and SCTs (510, a to b) cells, wherein:
the ICT (540, a to d) has been labelled with a fluorescent live-cell marker having an ICT emission/excitation profile different from the first and second emission/excitation profiles,
the dataset further comprises an ICT fluorescent image (503) from the fluorescent live-cell marker having the ICT emission/excitation profile,
wherein the status of the sample is further determined from
   at least one parameter of the ICT of Table 4 (Parameters 13 to 20), wherein the at least one parameter of the ICT comprises one or more of Parameters 13 to 20 of Table 3, and
      a presence or absence of an ICT, and/or
      a value(s) of the at least one parameter of the ICT, and/or
      a comparison of the at least one parameter of the ICT with a comparable reference, and/or
      an evolution of the at least one parameter of the ICT over time.

The ICT (540, a to d) may be:
immune cell(s), such as peripheral blood mononuclear cell (PBMC), natural killer cell, cytotoxic T-cell, macrophages, or
genetically engineered immune cell(s) such as Chimeric antigen receptor T (CAR-T), Chimeric Antigen Receptor-Engineered Natural Killer (CAR NK).

The sample co-culture may contain 1 to 10% (w/v) basement membrane matrix. The TCO (520) may be a patient-derived organoid or cancer cell line derived spheroid, and the SCT (510, a to b) may be a fibroblast or cancer activated fibroblast (CAF).

The sample may comprise multiple TCOs (520), and at least some of TCOs (520) each has a stroma, and/or at least some of TCOs (520) share a stroma.

Further provided herein is a computing device or system configured for performing a method as described herein.

Further provided herein is a program or computer program product having instructions which when executed by a computing device or system cause the computing device or system to perform a method as described herein.

Further provided herein is a computer readable medium having stored thereon instructions which when executed by a computing device or system cause the computing device or system to perform a method as described herein 1.

Further provided herein is a data stream representative of a computer program or computer program product having instructions which when executed by a computing device or system cause the computing device or system to perform a method as described herein.

### FIGURE LEGENDS

Schematic illustrations of fluorescent images obtained by present method is illustrated in FIG. 1 (panels A and B), FIG. 2 (panels A and B), FIG. 3 (panels A to F), and FIG. 4.

FIG. 1 Panels A and B depict a first fluorescent image (half-tone shaded) of a TCO (520) superimposed upon a second fluorescent image of associated SCTs (solid black filled) (510,a, 510,b). The stroma (512) is indicated being formed from two SCT clusters (Panel A, 514,a,b) or from one SCT cluster (Panel B, 514,a).

FIG. 2 Panels A and B depict three superimposed fluorescent images: a first fluorescent image (half-tone shaded) of a TCO (520), a second fluorescent image of associated SCTs (solid black filled) (510,a, 510,b) forming the stroma (512), and an SSCT (third) fluorescent image of SSCTs (530,a,b) (white filled)—some within the stroma (530,b) and some not a part of the stroma (530,a). The stroma (512) is indicated being formed from two SCT clusters (Panel A, 514, a,b) or from one SCT cluster (Panel B, 514,a).

FIG. 3 Panels A to F depict a first fluorescent image (half-tone shaded) of a TCO (520) superimposed upon a second fluorescent image of associated SCTs (solid black filled) (510,a, 510,b), and a sequence of stroma (512) formation. In Panel A, no stroma has formed. In Panels B to Panel F, a stroma (512) has formed that increases gradually in size by additional of clusters and/or increase in size of cluster and/or merging of clusters. Panel B shows formation of a 1st cluster (514, a), Panel C shows growth by area of the 1st cluster (514, a), Panel D shows a development of a 2nd cluster (514, b), Panel E shows a development of a 3rd cluster (514, c), Panel F shows a merging of the 2nd (514, b) and 3rd cluster (514, c) forming a single cluster (514, d).

FIG. 4 shows the TCO (520) and stroma (512) of FIG. 3 Panel F, additionally with an ICT (fourth) fluorescent image of a plurality ICTs (540, a to d) (solid white filled ovals). Further exemplarily indicated are different regions: stroma region (532, c); TCO region (532,d); ICT attraction region (532,b); and ICT diffusion region (532,a).

FIGS. 5 to 12. Quantification of multiple stromal parameters showing the (inter-patient) response differences upon treatment with various therapeutics.

FIG. 5 Graph showing normalized stromal growth rate upon treatment with Nintedanib (0.5 μM), TGF-B (5 ng/ml) and FGF2 (10 ng/ml).

FIG. 6 Graph showing dynamic (over time) kinetic quantification of the stromal size (area).

FIG. 7 Graph showing dynamic (over time) normalized contractility.

FIG. 8 Representative image showing the differences in contractility upon treatment with Nintedanib (0.5 μM) and FGF2 (10 ng/mL). Left: Plurality of TCO's (separated) each TCO containing a stroma. Some organoids are arranged in islands surrounded by a small stromal region; result of treatment with Nintedanib. Right: TCOs-stromas have been contracted together to form one “microtumour” comprising one larger TCO and one stroma; result of treatment with FGF2.

FIG. 9 Graph showing dynamic (over time) kinetic stroma ratio quantification highlighting the inhibitory effect of Nintedanib.

FIG. 10 Graph showing static (single point) endpoint measurement of the stromal density upon treatment with Nintedanib (0.5 μM), TGF-B (5 ng/ml) and FGF2 (10 ng/mL).

FIGS. 11 and 12 Graph showing stroma size measurements showing inter-patient differences upon treatment with standard of care chemotherapeutics.

### DETAILED DESCRIPTION OF INVENTION

Before the present method (and corresponding system, computer program, etc) of the invention are described, it is to be understood that this invention is not limited to particular methods, systems or computer programs or combinations described, since such methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the present description of the invention, reference is made to the accompanying drawings that form a part hereof, and in which are shown by way of illustration only of specific embodiments in which the invention may be practiced. Parenthesized or emboldened reference numerals affixed to respective elements merely exemplify the elements by way of example, with which it is not intended to limit the respective elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

It is to be understood that other embodiments may be utilised and structural or logical changes may be made without departing from the scope of the present invention. The following detailed description, therefore, is not to be taken in a limiting sense, and the scope of the present invention is defined by the appended claims.

Provided herein is a method for determining a status of a sample comprising a co-culture comprising a target cellular object, TCO, and a stroma-forming cell type, SCT. The co-culture provides a therapeutic model for cellular assemblies (3D micro-tumours), for instance, a cancer model, such as patient-derived cancer organoids (TCO) and cancer-associated fibroblasts (SCT).

The method comprises capturing, during an acquisition event using a microscope, at least one dataset of the co-culture sample in which TCO has been labelled with a live-cell fluorescent label having a first emission/excitation profile, and the SCT has been labelled with a live-cell fluorescent label having a second emission/excitation profile different from the first emission/excitation profile. The dataset comprises a first fluorescent image from the live-cell fluorescent label having the first emission/excitation profile, and a second fluorescent image from the live-cell fluorescent label having the second emission/excitation profile. A stroma for the TCO is identified from the second fluorescent image, and at least one parameter of the stroma (stroma parameter) is identified. The at least one stroma parameter allows a determinations of the assembly or disassembly process of the co-culture, and under native conditions or under an influence of an additive, such as a therapeutic agent or immune-type cells. The method is in vitro.

The data set may optionally further comprise a Bright field image, and/or additional fluorescent images, and/or a luminescent measurement of the sample as discussed elsewhere herein

The allows the study, for example, of activation of SCTs that are CAFs and how therapies affect this process. The CAFs are able to migrate, proliferate, produce of extracellular matrix, express different markers such as α smooth muscle actin (αSMA), platelet derived growth factor β (PDGFR β) and fibroblast activation protein (FAP) whereas normal fibroblasts express fibroblast stimulating protein 1 (FSP1) and α1β1 integrin. CAFs occur not only in tumours, but also in healing wounds and diseases with matrix remodelling such as chronic inflammation, heart infarction and liver and lung fibrosis, making our the present also relevant for studying other types of TCO. The stroma can protect the TCO, accordingly a method that takes into account its presence and formation allows better understanding of modulatory effects of potential active agents. The disclosure also allow study of additional cell types in the sample (e.g. immune cell types (ICT) and/or stroma-supporting cell type (SSCT).

The TCO and the SCT in the co-culture can be any in which the stroma is to be investigated. For each (one) TCO, there may be a (one) stroma formed of multiple cells of the stroma-forming cell type (SCT); this forms a TCO-stroma object. Alternatively or in addition, there may be multiple TCOs associated with a (one encompassing) stroma; this forms the TCO-stroma object. The sample culture may comprise multiple TCO-stroma objects. Present in the co-culture may be cells of the SCT not part of the stroma, but which may have motility and potential to migrate to and form part of the stroma. The co-culture may further comprise cells of a stroma-supporting cell type (530,a,b) (SSCT). The co-culture may further comprise cells of an immune cell type (ICT).

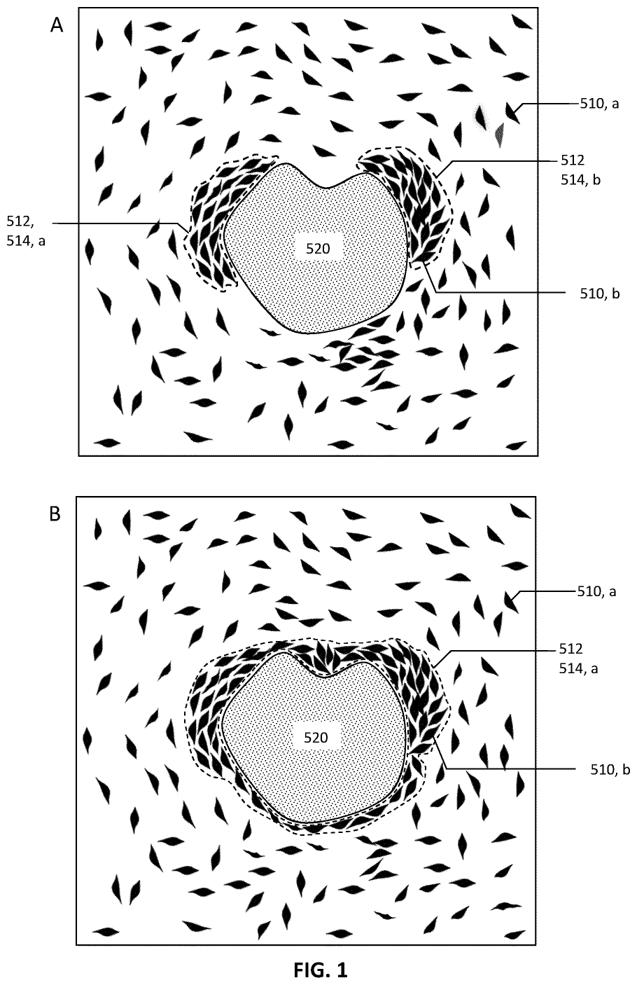

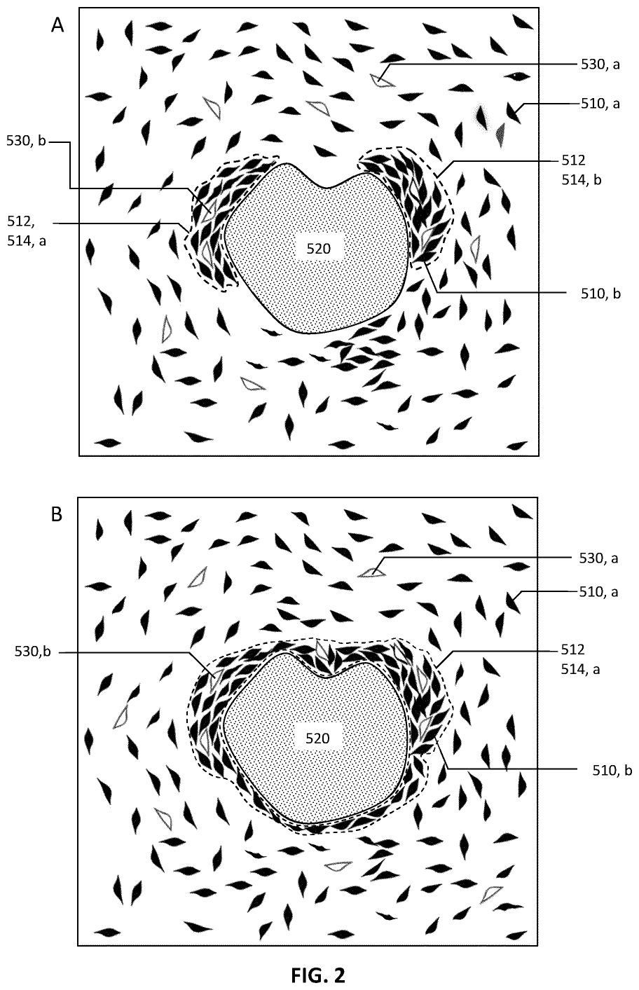

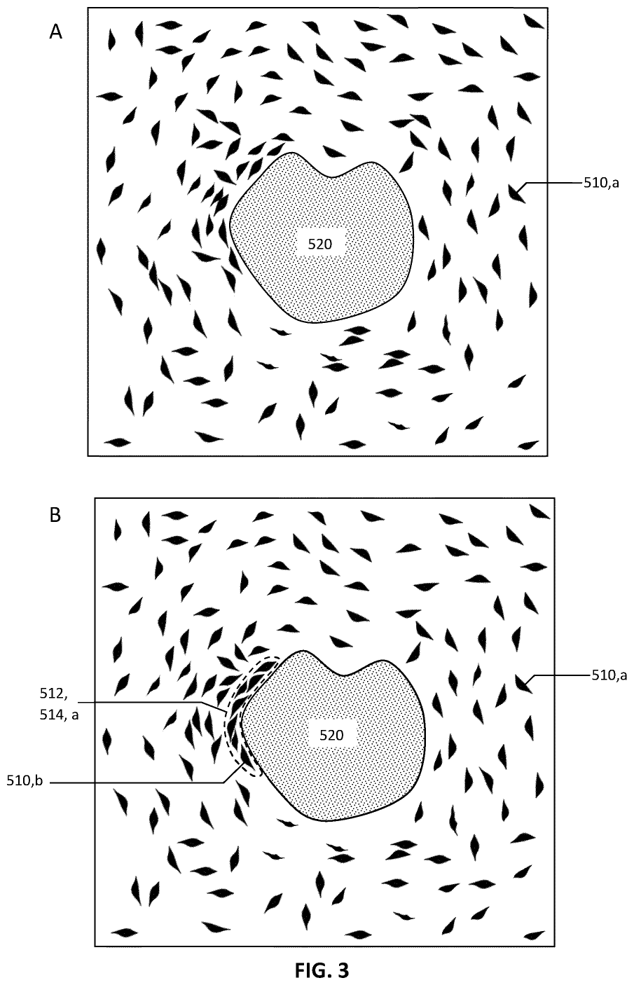

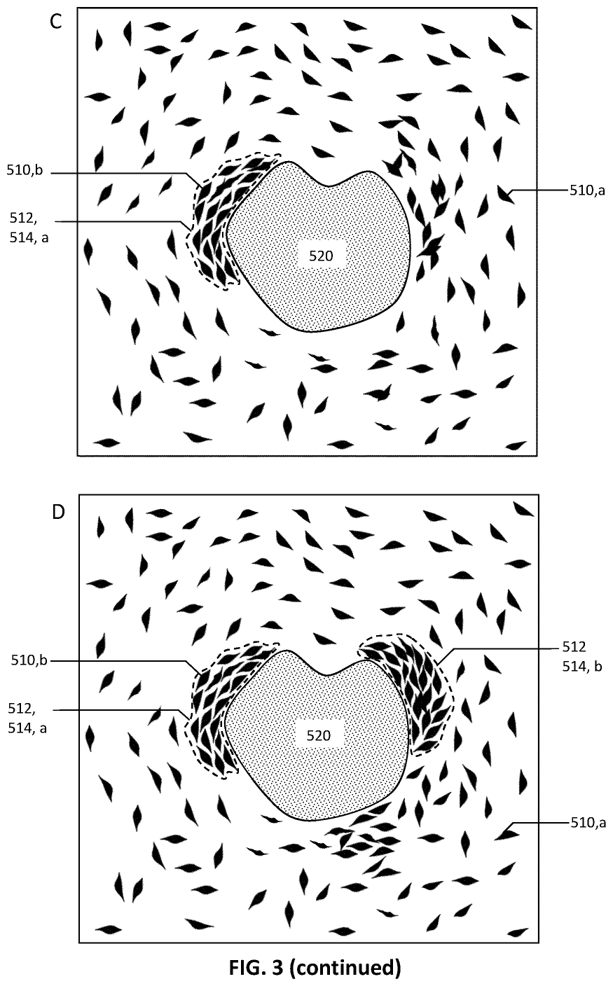

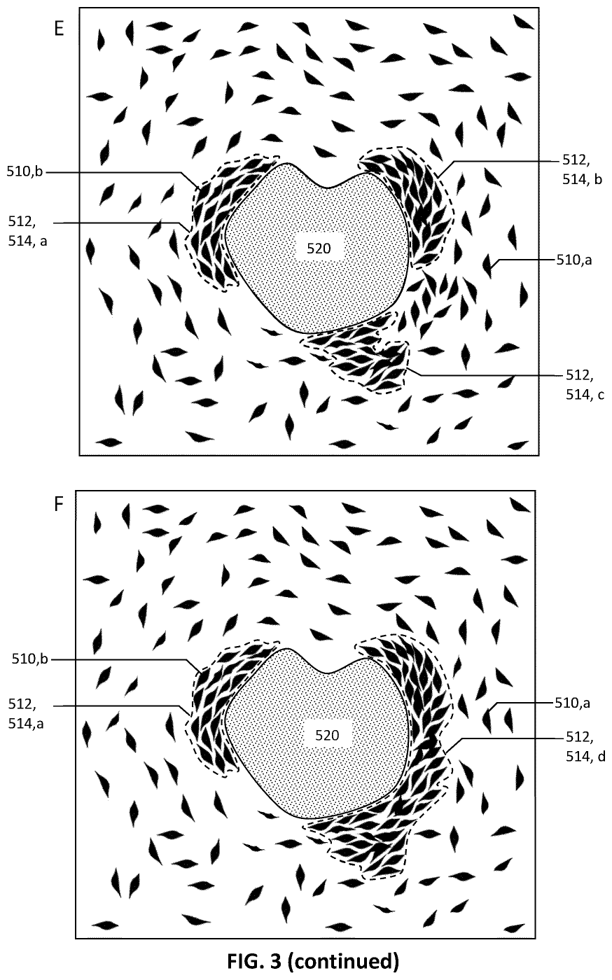

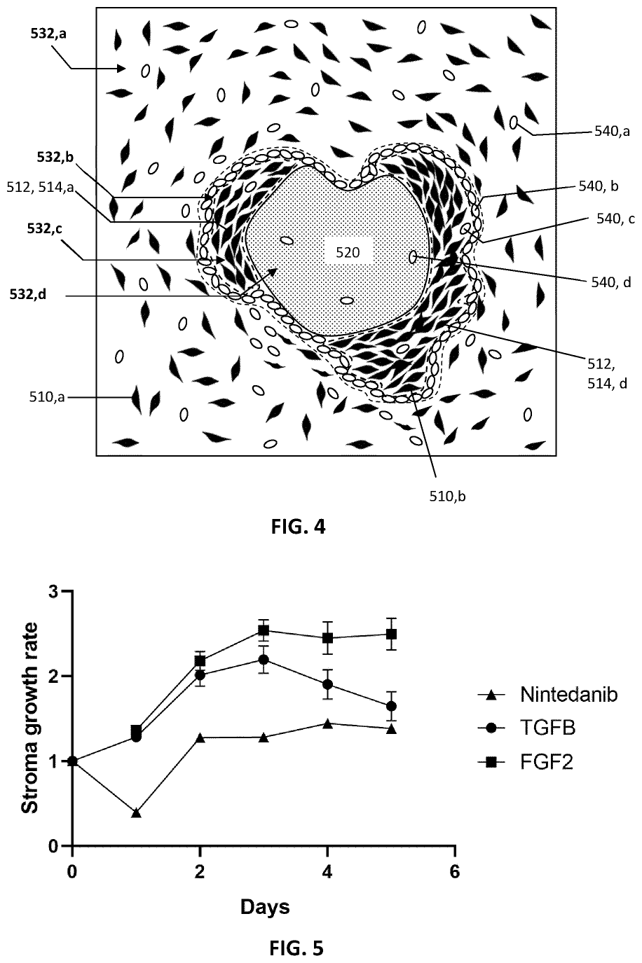

TCO (Target cellular object) is a three-dimension cellular assembly. It may be a spheroid or organoid. Cells in the TCO are of the same type. Cells in the TCO may be cancer cells. The TCO is preferably a patient-derived organoid or cancer cell line derived spheroid. The TCO is labelled with a fluorescent live-cell marker having a first emission/excitation profile different from the second emission/excitation profiles (and optionally from the other emission/excitation profiles where present). An exemplary TCO (520) is shown in FIG. 1 (Panels A and B), FIG. 2 (Panels A and B), FIG. 3 (Panels A to F), FIG. 4.

Cells of the SCT (Stroma-forming cell type) have motility and adhesion capability. An SCT cell has a capability of migrating towards the TCO and associating with it. A principle function of the SCT is to maintain the structural integrity of connective tissues in the stroma by continuously secreting precursors of the extracellular matrix. SCT may secrete the precursors of components of the extracellular matrix, primarily the ground substance and a variety of fibres. Examples of a specific SCT is a fibroblast, cancer-associate fibroblast (CAF). SCT is different from the TCO (and from SSCT and from ICT where present). The SCT cells are of the same type (e.g. all fibroblast(s), all cancer-activated fibroblasts (CAFs)). The sample may comprise one or more different SCTs. The stroma may comprise one or more different SCTs. The SCT is labelled with a second live-cell marker having a second emission/excitation profile different from the first emission/excitation profile (and optionally from the other emission/excitation profiles where present). Exemplary SCT cells (510, a (not part of the stroma), 510, b (part of the stroma)) are shown in FIG. 1 (Panels A and B), FIG. 2 (Panels A and B), FIG. 3 (Panels A to F), FIG. 4.

Cells of the SSCT (530,a,b) (Stroma-supporting cell type) have motility and adhesion capability. An SSCT cell has a capability of migrating towards the TCO (520) and associating with it, along with the SCT, thereby co-forming the stroma. SSCT may form a single cell layer that lines blood vessels and regulates exchanges between the bloodstream and the surrounding tissues. Signals from SSCT may organize the growth and development of connective tissue cells that form the surrounding layers of the blood-vessel wall. The SSCT may be added to the co-culture at the same time as the SCT. An example of a specific SSCT is endothelial cell. SSCT is different from SCT (and optionally from the other emission/excitation profiles where present). Where the stroma is formed from a SCT and a SST, the SCT is predominant in quantity. The SSCT is preferably labelled with an SSCT (third) live-cell marker having an SSCT (third) emission/excitation profile different from the first and second emission/excitation profiles (and optionally from the other emission/excitation profiles where present). Exemplary SSCT cells (530,a (not part of the stroma); 530,b (part of the stroma);) are shown in FIG. 2 (Panels A and B).

The sample co-culture may further comprise an immune cell type (ICT) different from the TCO, and from the SCT, and from the SSCT (where present). An ICT may be an immune cell(s) (PBMC, NK-cell, Cytotoxic T-cell, macrophages, . . . ) or genetically engineered immune cell(s) (CAR-T, CAR-NK, . . . ). The ICT may be added after formation of the stroma has stabilised. ICT cell trafficking towards or away from the stroma, and/or infiltration of ICT into the stroma and/or into the TCO may be determined. The ICT may be labelled with an ICT (fourth) live-cell marker having an ICT (fourth) emission/excitation profile different from the first and second emission/excitation profiles (and optionally from the other emission/excitation profiles where present). Exemplary ICT cells (540, a, b, c, d) are shown in FIG. 4.

In one combination, the TCO is a patient-derived organoid or cancer cell line derived spheroid and the SCT is fibroblast or cancer-activated fibroblast (CAF). In one combination, the TCO is a patient-derived organoid or cancer cell line derived spheroid, the SCT is fibroblast or cancer-activated fibroblast (CAF), and the SSCT is endothelial. In one combination, the TCO is a patient-derived organoid or cancer cell line derived spheroid, the SCT is fibroblast or cancer-activated fibroblast (CAF), and the SSCT is endothelial, and the ICT is one or more of PBMC, NK-cell, Cytotoxic T-cell.

The co-culture typically contains growth medium supportive of maintenance of cells. The growth medium typically contains a carbon source for growth (e.g. glucose), and nutrients. The medium may further contain one or more substances supporting formation of three-dimensional structures such as the TCO and stroma. An example of a structure-support substance includes basement membrane matrix (BME), such as, for instance Matrigel (Corning Life Sciences). The basement membrane matrix (BME) (e.g. Matrigel) may be present in a quantity of 1 to 10%, preferably 1 to 5% (w/v).

The status of the sample refers to the presence or absence of the stroma, and/or if present at least one parameter of the stroma (Table 1) and optionally at least one other measurable parameter (Table 2), and optionally at least one SSCT parameter (Table 3), and optionally at least one ICT parameter (Table 4). The status of the sample is indicative of the assembly process, in particular the state of stroma.

In particular, the status of the sample may be determined from one or more of:
a presence or absence of an identified stroma, and/or
an evolution, over time, for an identified stroma, of:
   the at least one stroma parameter (Table 1), and
   optionally of at least one other measurable parameter (Table 2), and
   optionally at least one SSCT parameter (Table 3), and
   optionally at least one ICT parameter (Table 4),
a comparison of:
   the at least one stroma parameter (Table 1)
   optionally of at least one other measurable parameter (Table 2), and
   optionally at least one SSCT parameter (Table 3), and
   optionally at least one ICT parameter (Table 4),
with a comparable reference,
a value(s) of the at least one stroma parameter, and
   optionally of at least one other measurable parameter (Table 2), and
   optionally at least one SSCT parameter (Table 3), and
   optionally at least one ICT parameter (Table 4)
(without comparison to a comparable reference).

The comparable reference is a like-for-like reference measurement of the same measured parameter (e.g. a stroma parameter (Table 1), an other measurable parameter (Table 2), an SSCT parameter (Table 3), or ICT parameter (Table 4)). For instance, where at least one stroma parameter of the captured dataset is stroma size (Parameter 1, Table 1), the comparable reference is also stroma size. A value of the comparable reference may be indicative of a normal value. The comparable reference is typically determined for a population. The comparable reference may be an optimised stroma. A comparable reference might be an untreated or vehicle treated sample that is not exposed to a potential active agent. Another example is a comparable reference with or without SSCT and/or ICT to study the influence of these cell types on the parameter (e.g. stroma size).

The measured parameter may be compared with the comparable reference using a variety of different protocols known to the skilled person, for instance, comprising taking a difference with the comparative reference, taking a ratio with the comparative reference, or both, or by any other comparison protocol.

Where multiple parameters are determined from an identified stroma, the status may indicate multiple separate values (without comparison to a reference) typically one for each parameter, and/or may indicate multiple separate values (with comparison to the comparable reference) typically one for each parameter, and/or may indicate multiple separate values (with or without comparison to the comparable reference) typically for each parameter and for each time point (evolution).

Where multiple parameters are determined from an identified stroma, the status may be represented by a combination of the parameters. The status may indicate a (single) combined value representing multiple separate values typically one value for each parameter (without comparison to a comparable reference), and/or a combined value representing multiple separate values typically one value for each parameter (with comparison to a reference), and/or a combined value representing multiple separate values (with or without comparison to the comparable reference) typically one value for each parameter and each time point (evolution over time). The combination is typically a (weighted or unweighted) statistical combination (mean, median), or any other protocol for combining values.

Where the status is determined from an evolution over time, the parameters that may contribute to the determining are indicated by the last column of Tables 1 to 4 (static and/or dynamic). An ‘either’ or ‘dynamic’ indication is indicative that the parameter that may contribute the determining the status from an evolution over time.

A parameter may be static or dynamic. A static measurement is a measurement at one point in time. Dynamic measurement refers to multiple measurements made over time. A dynamic measurement determines an evolution over time of at least one parameter. Where a dynamic measurement is made, multiple measurements may be made over a period of minutes, hours, or days.

Where the status represents an evolution over time of at least one parameter, the value may be an indicator of change over time (e.g. a differential, a gradient) of the at least one parameter (with or without comparison to the comparable reference).

The status may be expressed in any suitable manner, for instance, as a single scalar value, as multiple scalar values, as a graph, or the like.

Where the status is expressed as a single scalar value, the single scalar value may be:
a single value representing a measured parameter (with or without comparison to the comparative reference) measured at a single point in time, and there being only one measured parameter (e.g. parameter 1).
a combined (single) value representing a measurement of a multiple different measured parameters (with or without comparison to the comparative reference), each parameter measured as the same single point in time, (e.g. parameter 1 and 2). The multiple different measured parameters are combined into the combined value by (weighted or unweighted) statistical combination (mean, median), or any other protocol for combining values.
a single value representing a single measured parameter (with or without comparison to the comparative reference) measured at a multiple different points in time, and there being only one measured parameter (e.g. parameter 1). The single value is an indicator of change over time (e.g. a differential, a gradient) of the single (one) parameter.
a time-combined (single) value representing a measurement of a multiple different measured parameters (with or without comparison to the comparative reference), each parameter measured as the multiple points in time (e.g. parameter 1ₜ₌₁, parameter 2ₜ₌₁, parameter 1ₜ₌₂, parameters 2ₜ₌₂). The multiple different measured parameters at each time point are combined into the combined value by (weighted or unweighted) statistical combination (mean, median), or any other protocol for combining values. The single value is an indicator of change over time (e.g. a differential, a gradient) of the combined value.

Where the status is expressed as multiple scalar values, the multiple scalar values may be:
multiple values, each value being of a single measured parameter (without comparison to the comparative reference) at a single point in time, and there being multiple different measured parameters (e.g. parameter 1 and 2).
   multiple values, each value being of a single measured parameter compared with the comparative reference at a single point in time, and there being multiple different measured parameters (e.g. parameter 1 and 2).
   multiple values, each value being a single measured parameter (without comparison to the comparative reference) measured at a different point in time (evolution), and there being multiple measurements at different time points, and there being one measured parameter (e.g. parameter 1).
   multiple values, each value being a single measured parameter (without comparison to the comparative reference) measured at a different point in time (evolution), and there being multiple measurements at different time points, and there being multiple different measured parameters (e.g. parameter 1 and 2).
      i. The status may contain a list of multiple time points of multiple different measured parameters.
      ii. The status may contain a list of multiple time points of combined values, wherein each combined value is a combination of the multiple different measured parameters at each time point (e.g. values representing combined parameters 1 and 2, each value at a different time point). The multiple different measured parameters are combined into the single value by (weighted or unweighted) statistical combination (mean, median), or any other protocol for combining values.
      iii. The status may contain a list of multiple gradients, wherein one gradient per different measured parameter (e.g. values representing combined parameters 1 and 2, each value at a different time point).

At least one parameter of the stroma, also known as a stroma parameter, is determined from the stroma as identified in the second fluorescent image. Examples of stroma parameters are provided in Table 1. A stroma parameter may be static or dynamic. A static measurement is a measurement at one point in time. Dynamic measurement refers to multiple measurements made over time. A dynamic measurement determines an evolution over time of at least one parameter. Where a dynamic measurement is made, multiple measurements may be made over a period of minutes, hours, or days.

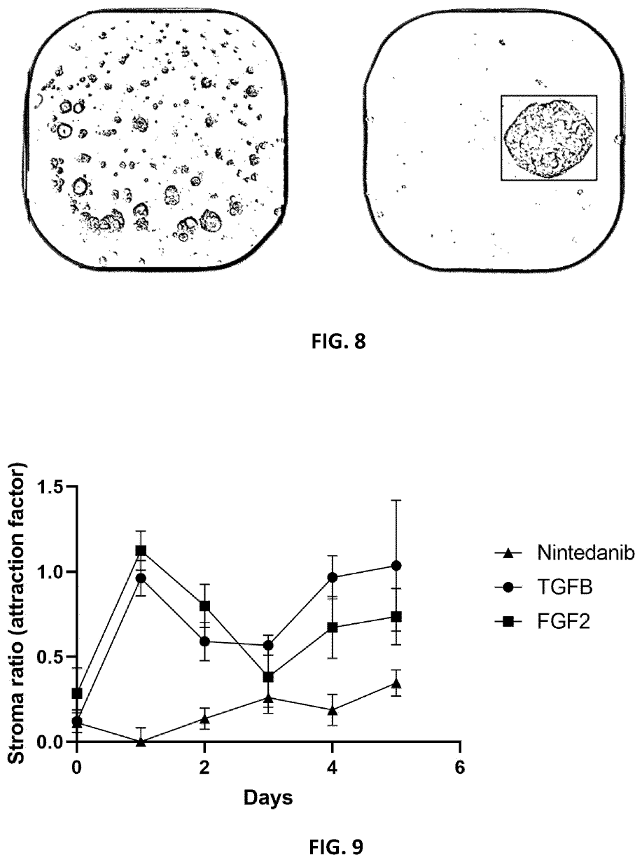

TABLE 1
Stroma parameters measurable from the second fluorescent image.

| | Stroma | | Static and/or |
|---|---|---|---|
| Parameter | parameter | Description | dynamic¹ |
| 1 | Stroma size | Determined from an area of the Stroma in the | Either |
| | | second fluorescent image. | |
| 2 | Stroma size | Determined from a ratio of [Parameter 1] and | Either |
| | ratio | total area of the SCTs in the second fluorescent | |
| | | image. | |
| 3 | Stroma | Determined from a ratio of [Parameter 1] and | Either |
| | density | the sum ([Parameter 1] and area of the TCO in | |
| | | the first fluorescent image) | |
| 4 | Stroma-free | Determined from a rate (and optionally | Dynamic |
| | SCT velocity | direction) of movement of SCTs not part of a | |
| | (=stromal | Stroma. Determined by tracking movement of | |
| | velocity) | the SCTs not part of a Stroma in the second | |
| | | fluorescent image. | |
| 5 | Contractility | Change in distribution of the TCO and SCT, | Either |
| | | from multiple spatially separated TCO-stromas | |
| | | towards a clump of TCO cells and SCT cells. | |
| | | Exemplified in FIG. 8. | |
| | | This may be measured as a reduction in a | |
| | | bounding box area encompassing TCO(s) and | |
| | | SCT cells in the first and second fluorescent | |
| | | image. The bounding box may further be | |
| | | defined as the containing lengths of first and | |
| | | second orthogonal moments describing a | |
| | | distribution of the TCO(s) and SCT cells. | |

¹Static measurement is a measurement at one point in time, typically an end point; dynamic measurement refers to multiple measurements made over time.

Optionally, at least one other measurable parameter is determined from the first and optionally second fluorescent image. Examples of other measurable parameters are provided in Table 2. An other measurable parameter may be static or dynamic. A static measurement is a measurement at one point in time. Dynamic measurement refers to multiple measurements made over time (e.g. a period of minutes, hours, or days).

TABLE 2
Other measurable parameters measurable from
the first and/or second fluorescent image.

| | Other | | |
|---|---|---|---|
| | measurable | | Static and/or |
| Parameter | parameter | Description | dynamic¹ |
| 6 | SCT growth | Growth rate of the SCT. It is a measure in a | Dynamic |
| | (May be | change in area over time of the SCTs in the | |
| | known as | second fluorescent image. It may be normalised | |
| | Fibroblast | to the area of SCT measured at time zero (T0) | |
| | growth) | | |
| 7 | TCO growth | Growth rate of TCO. It is a measure in a change | Dynamic |
| | ((May be | in area over time of the first fluorescent image. | |
| | known as | More preferably, change in area over time of the | |
| | Cancer cell | TCO in the first fluorescent image. It may be | |
| | growth) | normalised to the area measured in the first | |
| | | fluorescent image at time zero (T0). It may be | |
| | | normalised to the area of TCO measured at time | |
| | | zero (T0). | |
| 8 | TCO cell | May be measured by: | Either |
| | death | Inclusion of a fluorescent cell death marker to | |
| | | measure cell type specific cell death by overlap | |
| | | of fluorescent cell death image with first | |
| | | fluorescent image. | |
| | | Inclusion of a luminescent cell death marker to | |
| | | assess cell type specific cell death. | |
| | | TCO cell death may be measured as described | |
| | | later below. | |

¹Static measurement is a measurement at one point in time, typically an end point; dynamic measurement refers to multiple measurements made over time.

The status of the sample may be further determined from:
at least one other measurable, wherein at least one other parameter comprises one or more of Parameter 6, Parameter 7, Parameter 8, of Table 2, and
   a value(s) of the at least one other measurable parameter, and/or
   a comparison of the at least one other measurable parameter with a comparable reference, and/or
   an evolution of the at least one other measurable parameter over time.

The sample co-culture may further comprise a stroma-supporting cell type (SSCT) different from the TCO and from the SCT (and from the ICT where present). The SSCT may be added to the co-culture at the same time as the SCT. The status of the sample may be further determined from at least one parameter of the SSCT. The SSCT may be endothelial.

The status of the sample may be further determined from:
at least one parameter of the SSCT, wherein at least one parameter of the SSCT comprises one or more of Parameter 9, Parameter 10, Parameter 11, Parameter 12 of Table 3,
and
   a presence or absence of a SSCT, and/or
   a value(s) of the at least one parameter of the SSCT of an identified stroma, and/or
   a comparison of the at least one parameter of the SSCT of an identified SSCT with a comparable reference, and/or
   an evolution of the at least one parameter of the SSCT over time of an identified SSCT.

The SSCT has been labelled with a fluorescent live-cell marker having an SSCT (third) emission/excitation profile different from the first and second emission/excitation profiles (and from the other emission/excitation profiles where present). The dataset further comprises a SSCT (third) fluorescent image from the fluorescent live-cell marker having the SSCT emission/excitation profile. The status of the sample is further determined from at least one parameter of the SSCT (SSCT parameter) of Table 3 (Parameters 9 to 12).

TABLE 3
SSCT parameters measurable from the SSCT fluorescent image, optionally
in combination with the first and/or second fluorescent image.

| | SSCT | | Static and/or |
|---|---|---|---|
| Parameter | Parameter | Description | dynamic¹ |
| 9 | SSCT growth | Growth rate of the SSCT. It is a measure in a | Dynamic |
| | (May be | change in area over time of the SSCTs in the | |
| | known as | SSCT fluorescent image. It may be normalised | |
| | endothelial | to the area of SSCT measured at time zero (T0) | |
| | growth | | |
| 10 | SSCT cell | May be measured by: | Either |
| | death | Inclusion of a fluorescent cell death marker to | |
| | | measure cell type specific cell death by overlap | |
| | | of fluorescent cell death image with SSCT | |
| | | fluorescent image. | |
| | | Inclusion of a luminescent cell death marker to | |
| | | assess cell type specific cell death. | |
| | | SSCT cell death may be measured as described | |
| | | later below. | |
| 11 | SSCT-stroma | Determined from a ratio of (area of the SSCT | Either |
| | distribution | present in the stroma region as determined from | |
| | ratio | the SSCT and second fluorescent image) and | |
| | | total area of SSCT in the SSCT fluorescent | |
| | | image. | |
| 12 | SSCT TCO | Determined from a ratio of (area of the SSCT | Either |
| | distribution | present in the TCO region as determined from | |
| | ratio | the SSCT and first fluorescent image) and total | |
| | | area of SSCT in the SSCT fluorescent image. | |

¹Static measurement is a measurement at one point in time, typically an end point; dynamic measurement refers to multiple measurements made over time.

The sample co-culture may further comprise an immune cell type (ICT) different from the TCO and from the SCT. The ICT may be added after formation of the stroma has stabilised. ICT cells trafficking towards or away from the stroma, and/or infiltration of ICT into the stroma and/or into the TCO, and/or ICT cells cluster around a periphery of the stroma may be determined. The status of the sample may be further determined from at least one parameter of the ICT.

The status of the sample may be further determined from:
at least one ICT parameter, wherein at least one ICT parameter comprises one or more of Parameter 13 to 20 of Table 4, and
   a presence or absence of an ICT, and/or
   a value(s) of the at least one ICT parameter of an identified ICT, and/or
   a comparison of the at least one ICT parameter of an identified ICT with a comparable reference, and/or
   an evolution of the at least ICT parameter over time of an identified ICT.

The ICT may be:
any immune cell(s), such as peripheral blood mononuclear cell (PBMC), natural killer cell, cytotoxic T-cell, macrophages, or
genetically engineered immune cell(s) such as Chimeric antigen receptor T (CAR-T), Chimeric Antigen Receptor-Engineered Natural Killer (CAR NK).

The ICT has been labelled with a fluorescent live-cell marker having an ICT (fourth) emission/excitation profile different from the first and second emission/excitation profiles (and from the other emission/excitation profiles where present). The dataset further comprises an ICT (fourth) fluorescent image from the fluorescent live-cell marker having the ICT emission/excitation profile. The status of the sample is further determined from at least one parameter of the ICT (ICT parameter) of Table 4 (Parameters 13 to 16).

TABLE 4
ICT parameters measurable from the ICT fluorescent image, optionally
in combination with the first and/or second fluorescent image.

| | | | Static and/or |
|---|---|---|---|
| Parameter | ICT Parameter | Description | dynamic¹ |
| 13 | ICT-stroma | A quantification of the ICT cells (540, c) located in the | Either |
| | infiltration | stroma region (532, c) determined from a quantity of | |
| | density | ICTcells in the stroma region (identified from the | |
| | ICT-S-ID | ICT/second fluorescent images), compared with all | |
| | | the ICTcells (540, a to d) in ICT fluorescent image. | |
| | | Preferably based on area. | |
| | | ICT-S-ID may be ratio of | |
| | | [area ICTs in the Stroma region (532, c) determined | |
| | | from the ICT fluorescent image] and [area ICTs | |
| | | (540, a to d) in ICT fluorescent image] | |
| 14 | (ICTS-ID)/ | Ratio [parameter 13] and [parameter 8] | Either |
| | TCO death | | |
| | ratio | | |
| 15 | ICT-TCO | A quantification of the ICT cells (540, d) located in the | Either |
| | infiltration | TCO region (532, d) determined from a quantity of | |
| | density | ICT cells in the TCO region (identified from the | |
| | ICT-TCO-ID | ICT/first fluorescent images), compared with all the | |
| | | ICTs (540, a to d) in ICT fluorescent image. | |
| | | Preferably based on area. | |
| | | ICT-TCO-ID may be ratio of | |
| | | [area ICT cells in the TCO region (532, d) determined | |
| | | from the ICT/first fluorescent image] and [area ICT | |
| | | cells (540, a to d) in ICT fluorescent image] | |
| 16 | (ICT-TCO-ID)/ | Ratio [15] and [8] | Either |
| | TCO death | | |
| | ratio | | |
| 17 | ICT-attraction | A quantification of the ICT cells (540, b) located in an | Either |
| | region | ICT attraction region (532, b) determined from a | |
| | infiltration | quantity of ICT cells in the ICT attraction region | |
| | density | (identified from the ICT/second and optionally first | |
| | ICT-AR-ID | fluorescent images), compared with all the ICT cells | |
| | | (540, a to d) in ICT fluorescent image. Preferably | |
| | | based on area. | |
| | | ICT-AR-ID may be ratio of | |
| | | [area ICT cells in the ICT attraction region (532, b) | |
| | | determined from the ICT fluorescent image] and | |
| | | [area ICT cells (540, a to d) in ICT fluorescent image] | |
| 18 | ICT attraction | Rate (and optionally direction) of movement of the | Dynamic |
| | region velocity | ICT cells from ICT diffusion region (532, a) into the | |
| | ICT-AR-V | ICT attraction region (532, b). Determined based on | |
| | | tracking movement of the ICT cells, not part of an | |
| | | Stroma (512) and not part of the TCO (510) in the | |
| | | ICT fluorescent image. | |
| | | A velocity of an ICT cell (540, b) above a certain | |
| | | threshold may be indicative of an active ICT being | |
| | | attracted to an TCO and/or SCT in the ICT attraction | |
| | | region (532, b). | |
| 19 | ICT diffusion | A quantification of the ICT cells (540, a) located in the | Either |
| | region density | ICT diffusion region (532, a) determined from the | |
| | ICT-DR-D | ICT/second/first fluorescent images, compared with | |
| | | all the ICTs (540, a to d) in ICT fluorescent image. | |
| | | Preferably based on area. | |
| | | ICT-DR-ID may be ratio of | |
| | | [area ICTcells in the ICT diffusion region (532, a) | |
| | | determined from the ICT/second/first fluorescent | |
| | | images] and [area ICTs (540, a to d) in ICT | |
| | | fluorescent image] | |
| 20 | ICT diffusion | Rate (and optionally direction) of movement of the | Dynamic |
| | region velocity | ICT cells in the ICT diffusion region (532, a). | |
| | ICT-DR-V | Determined based on tracking movement of the ICT | |
| | | cells outside the TCO region (532, d), outside stroma | |
| | | region (532, c), and outside the ICT attraction region | |
| | | (532, b). A velocity of an ICT cell (540, a) below a | |
| | | certain threshold may be indicative of an inactive ICT | |
| | | cell being in an ICT diffusion region (532, a). | |

¹Static measurement is a measurement at one point in time, typically an end point; dynamic measurement refers to multiple measurements made over time.

A TCO region (532,d) may be identified in the first fluorescent image, and is a region corresponding to the TCO (520) (FIG. 4).

A stroma region (532, c) may be identified in the second fluorescent image, and is a region 10 corresponding to the stroma (512) surrounding the TCO (520) (FIG. 4).

ICT attraction region (532,b) may be identified in the ICT fluorescent image, is outside the TCO region (532,d) and outside and adjacent to stroma (512) region (532, c) to which ICT cells are attracted, and is a region containing one or more clusters of ICT cells (FIG. 4). A cluster of ICT cells comprises a plurality of ICT cells (540,b) and each ICT cell in the cluster directly contacts the TCO (520) or stroma (512) or indirectly contacts the TCO (520) or stroma (512) via one or more other ICT cells (540,b). The ICT cells in the ICT attraction region (532,b) may form a complete or incomplete ring around the stroma (512) region (532, c). ICT cells that are attracted towards the TCO region (532,d) cluster together in the ICT attraction region (532,b).

ICT diffusion region (532,a) may be identified in the ICT fluorescent image, is outside the TCO region (532,d), outside stroma (512) region (532, c), and outside the ICT attraction region (532,b) (FIG. 4).

The microscope has a fluorescence imaging mode for acquisition of one, two or more fluorescence images of the sample at different emission/excitation profiles, and optionally a Brightfield (BF) imaging mode for acquisition of a Brightfield image of the sample. The images may be a static image, or a part of a moving image (real-time acquisition). The microscope may further have a luminescence measurement mode for measurement of luminescence of the sample. The microscope is configured to capture the one or more fluorescence images, and optionally the luminescence and the optional BF image in the acquisition event. An acquisition event is a capture by the microscope of a plurality of images simultaneously or near-simultaneously such that the position and orientation of the cell type (TCO, SCT, SSCT where present, ICT where present) in the respective images is the same. Typically, the delay between separate captures is in an order of tens of milliseconds. The fluorescence imaging mode operates at a plurality of different wavelengths or channels, in order to capture selectively different fluorescent images at different emission wavelength bands (e.g. blue, green and red). The microscope is configured to capture an optional Brightfield image, and a first fluorescent image at a first excitation and/or emission wavelength band, and a second fluorescent image at a second excitation and/or emission wavelength band, and optional further fluorescent images at a further excitation and/or emission wavelength bands in the acquisition event. The microscope may be provided with a multi-well plate reading platform that moves a multi-well plate holding a plurality of different samples so a well can be measured by the microscope. Example of a suitable microscope includes the Tecan Spark Cyto.

The TCO and SCT are each labelled with a distinct live cell fluorescent label that allows the cell type to be independently fluorescently imaged. The TCO is labelled with a first live-cell fluorescent label having a first emission/excitation profile, and the SCT is labelled with a second live-cell fluorescent label having a second emission/excitation profile that is different from the first. The SSCT (where present) is preferably labelled with a live-cell fluorescent label having an SSCT (third) emission/excitation profile. The ICT (where present) may be labelled with an ICT (fourth) live-cell fluorescent label having an ICT (fourth) emission/excitation profile.

Each label allow the cells to be imaged separately from the other by changing the excitation wavelength and/or the detection wavelength. The live cell fluorescent label highlights the cell type in any state (e.g. morphological state, internal state), and also in real-time. Debris is not labelled and non-cellular objects are not labelled. Examples of live cell fluorescent label include nucleic acid dyes including the Hoechst series of fluorescent dyes (e.g. Hoechst 33258 (blue), 34580 (red), 33342 (green)), Nuclight Red (Sartorius), Nuclight Green (Sartorius), Cytolight Green (Sartorius), Cytolight Red (Sartorius), Green fluorescent protein (GFP), Red fluorescent protein (RFP), mCherry (far red).

The fluorescent label may be an additive that is added to the cell type (TCO and SCT, optionally SSCT, optionally ICT), and contact of the additive with the cell type causes binding and fluorescent labelling; this may be called a transient fluorescent label. Examples include the Hoechst series of fluorescent dyes. To prevent mixing of labels, the cell type may be labelled prior to addition to the sample.

The fluorescent label may be introduced into the cell type (TCO and SCT, optionally SSCT, optionally ICT) as a gene (e.g. by transfection or transduction of a vector) that expresses a fluorescent label or that expresses a tag that reacts with one or more other substances to produce fluorescence; this may be called a stable fluorescent label. Examples include Red fluorescent protein (RFP), Green fluorescent protein (RFP), mCherry, NucLight/Cytolight Red/Green Lentivirus Reagent (Sartorius).

Stroma (512) is a structure identified from the second fluorescent image, comprising at least one cluster (514, a to d) contacting the TCO. An exemplary stroma (512) is shown in each of FIG. 1 (Panels A and B), FIG. 2 (Panels A and B), FIG. 3 (Panels A to G), FIG. 4. Exemplary cluster(s) forming each stroma (514, a to d) are shown in each of FIG. 1 (Panels A and B), FIG. 2 (Panels A and B), FIG. 3 (Panels B to F), FIG. 4. The stroma is different from the TCO. The stroma at least partially surrounds and contacts the TCO. The stroma may be dispersed continuously or discontinuously around the TCO. Each continuous portion of stroma is a cluster.

A cluster (514, a to d) comprises a plurality of cells of the SCT (510, b) and each SCT cell (510, b) in the cluster (514, a to d) directly contacts the TCO (520) or indirectly contacts the TCO (520) via one or more other SCTs (510). In each of FIG. 1 (Panels A and B), FIG. 3 (Panels B to F), FIG. 4 the cluster is formed from SCT cells (510, b).

A cluster (514, a to d) may further comprise a plurality of cells of a stroma-supporting cell type (SSCT) (530,b). Where the stroma further comprises a SSCT cells, the cluster (514, a to d) comprises a plurality of SCT cells (510, b) and each SCT cell (510, b) in the cluster (514, a to d) directly contacts the TCO (520) or indirectly contacts the TCO (520), or via one or more other SCT cells (510, b), and/or via one or more SSCT cells (530,b). In FIG. 2 (Panels A and B) the cluster is formed from SCT cells (510, b) and SSCT (530,b) cells.

A cluster is (circumferentially) continuous around the TCO or portion thereof. A plurality of clusters (514, a to d) may be disposed around a (one) TCO (e.g. FIG. 1 (Panel A), FIG. 2 (Panel A), FIG. 3 (Panel B to F), FIG. 4). Each cluster (514, a to d) in the plurality of clusters (514, a to d) is spatially separated from an adjacent cluster (514, a to d). One cluster (514, a to d) may be disposed continuously around a (one) TCO (intact perimeter) (e.g. FIG. 1 (Panel B), FIG. 2 (Panel B)).

A (one) stroma (512) is associated with a single (one) TCO (520), or a stroma is associated with a plurality of TCOs (520). In other words, the sample may comprise multiple TCOs, and at least some of TCOs (520) may each have a (one) stroma, and/or at least some of TCOs share a (common) stroma. Where the stroma is associated with a plurality of TCOs (520), the TCOs are typically grouped together, and
an SCT cell may contact directly and indirectly one or more TCOs (520), or
an SCT cell may indirectly two or more TCOs (520).

An SCT stroma has a outer boundary that is formed of an outer (final) layer of SCT cells (optionally containing one or more SSCT cells where present) that are connected to the TCO.

An SCT stroma has an inner boundary that is an inner layer of SCT cells (optionally containing one or more SSCT cells where present) abutting an outer edge of the TCO.

A stroma may be identified manually or automatically from the second fluorescent image. It may be identified from a region/cluster in second fluorescent area that is close or adjacent to the first fluorescent area TCO

Further provided herein is a screening method for determining an effect of a potential active agent on a sample comprising a co-culture comprising the target cellular object, TCO, and the stroma. The method comprises determining using the method disclosed herein, a test status of the sample contacted with the potential active agent and a control status of the sample not contacted with the potential active agent. Any effect of the potential active agent is determined from a change of status between the test sample and the status control sample.

The test status may be determined from a test dataset captured of the sample contacted with the potential active agent and the control status may be determined from a control dataset captured of the sample not contacted with the potential active agent. Any effect of the potential active agent is determined from a change between the test dataset and the control dataset.

A change in status in the absence and presence (usually at varying concentrations) of the potential therapeutic agent allows a determination of an effect of the potential therapeutic agent. The assays may be performed continuously (real time) or at one or more discrete time points. The screening method may be on multiple test samples held on multi-well plates (e.g. 384 well). The effect may be therapeutic (e.g. cytotoxic, inhibition of growth, cell death), adverse (e.g. stimulation of growth, cell proliferation), or non-therapeutic (e.g. same effect as control). The control status may be captured for the sample prior to contact with the potential active agent. The control status may be captured for a control sample not contacted with the potential active agent, and that is separate from a control status captured for a test sample contacted with the potential active agent.

The potential active agent may be an anti-cancer (e.g. tumour) agent.

The screening method described herein may comprise a step of determining the stroma size (Stroma parameter 1). The effect of the potential active agent is determined from a change in Stroma size in the test status and a control status. The effect may be determined at one or at a plurality of time points. The effect of the potential active agent may be determined from a change in stroma size over time between the test status and a control status.

An increase or decrease in Stroma size compared with the control may be indicative that potential active agent has an effect. An increase or decrease in stroma size over time compared with the control may be indicative that potential active agent has an effect. The effect may be cytotoxic. The effect may be therapeutic.

The screening method described herein may comprise a step of determining the Stroma size ratio (Stroma parameter 2). The effect of the potential active agent is determined from a change in Stroma size ratio in the test status and a control status. The effect may be determined at one or at a plurality of time points. The effect of the potential active agent may be determined from a change in Stroma size ratio over time between the test status and a control status.

An increase or decrease in Stroma size ratio compared with the control may be indicative that potential active agent has an effect. An increase or decrease in Stroma size ratio over time compared with the control may be indicative that potential active agent has an effect. The effect may be cytotoxic. The effect may be therapeutic.

The screening method described herein may comprise a step of determining the Stroma density (Stroma parameter 3). The effect of the potential active agent is determined from a change in Stroma density in the test status and a control status. The effect may be determined at one or at a plurality of time points. The effect of the potential active agent may be determined from a change in Stroma density over time between the test status and a control status.

An increase or decrease in Stroma density compared with the control may be indicative that potential active agent has an effect. An increase or decrease in Stroma density over time compared with the control may be indicative that potential active agent has an effect. The effect may be cytotoxic. The effect may be therapeutic.

The screening method described herein may comprise a step of determining the Stroma-free SCT velocity (Stroma parameter 4). The effect of the potential active agent is determined from a change in Stroma-free SCT velocity in the test status and a control status. The effect may be determined at one or at a plurality of time points. The effect of the potential active agent may be determined from a change in Stroma-free SCT velocity over time between the test status and a control status.

An increase or decrease in stroma-free SCT velocity compared with the control may be indicative that potential active agent has an effect. An increase or decrease in stroma-free SCT velocity over time compared with the control may be indicative that potential active agent has an effect. The effect may be cytotoxic. The effect may be therapeutic.

The screening method described herein may comprise a step of determining the contractility (Stroma parameter 5). The effect of the potential active agent is determined from a change in contractility in the test status and a control status. The effect may be determined at one or at a plurality of time points. The effect of the potential active agent may be determined from a change in contractility over time between the test status and a control status.

An increase or decrease in contractility compared with the control may be indicative that potential active agent has an effect. An increase or decrease in contractility over time compared with the control may be indicative that potential active agent has an effect. The effect may be cytotoxic. The effect may be therapeutic.

Death of cells within the sample (e.g. one or more of TCO, SCT, SSCT (where present) ICT (where present)) may be measured by optical measurement methods such as fluorescence or luminescence.

Cell death may be quantified by addition to the sample of a quantitative fluorescent cell-death marker (e.g. Cytotox green/red, CellTox green) having a cell death (fifth) emission/excitation profile different from the first emission/excitation profile, second emission/excitation profile, and from other emission/excitation profiles where present. The dataset further comprises a cell death (fifth) fluorescent image from the fluorescent cell-death marker having the cell death emission/excitation profile. Cell death is determined (at least) from the cell death fluorescent image captured in the dataset.

Cell death may be quantified by the measured fluorescence in the cell death fluorescent image, in particular from the area of fluorescent cell-death marker observed in the cell death fluorescent image.

A cell type visible on one of fluorescent images (e.g. TCO on first fluorescent image, SCT on second fluorescent image, SSCT on SSCT fluorescent image, ICT on ICT fluorescent image) will appear at the same location the cell death fluorescent image after cell death.

Cell death may be determined from the measured fluorescence alone, or taking into account a measured quantity of cells of the cell type. For example, cell death may be determined or quantified, for each dataset, from the fluorescent area in the cell death fluorescent image, and a cell type fluorescent area (e.g. fluorescent area of TCO in first fluorescent image, fluorescent area of SCT in second fluorescent image, fluorescent area of SSCT in SSCT fluorescent image, fluorescent area of ICT in ICT fluorescent image.

For example, cell death may be determined or quantified, for each dataset, thus:
TCO cell death: a ratio of fluorescent area in the cell death fluorescent image and fluorescent area in the first fluorescent image, or
SSCT cell death: a ratio of fluorescent area in the cell death fluorescent image and fluorescent area in the DDCT fluorescent image.

Cell death may be quantified by transfecting one or more of cell types (TCO, SCT, SSCT (where present), ICT (where present)) with a vector expressing a polypeptide (e.g. HiBiT) that is released into the supernatant death of that cells occurs and that can be quantified by adding a substrate and measuring the luminescent signal. Cell death measured will be specific to the cell type (TCO, SCT, SSCT (where present) ICT (where present))

The luminescence measurement in the dataset is proportional cell death, in particular to a quantity of cells in the one or more of cell type(s) having died. Cell death may be determined from the measured luminescence alone or taking into account a measured quantity of cells in the one or more of cell types. The quantity of cells in the one or more of cell types may be determined using the fluorescent image.

TCO cell death may be determined or quantified, for each dataset, from the luminescence captured from the suitably transfected TCO, and one or more of fluorescent area in the first fluorescent image and fluorescent intensity in the first fluorescent image. For example, cell death may be determined or quantified, for each dataset, from:
a ratio of luminescence and fluorescent area in the first fluorescent image, or
a ratio of luminescence and fluorescent intensity in the first fluorescent image, or
a ratio of luminescence and a mean of fluorescent intensity and fluorescent area in the first fluorescent image.

SCT cell death may be determined or quantified, for each dataset, from the luminescence captured from the suitably transfected SCT, and one or more of fluorescent area in the second fluorescent image and fluorescent intensity in the second fluorescent image. For example, SCT cell death may be determined or quantified, for each dataset, from:
a ratio of luminescence and fluorescent area in the second fluorescent image, or
a ratio of luminescence and fluorescent intensity in the second fluorescent image, or
a ratio of luminescence and a mean of fluorescent intensity and fluorescent area in the second fluorescent image.

SSCT cell death may be determined or quantified, for each dataset, from the luminescence captured from the suitably transfected SSCT, and one or more of fluorescent area in the SSCT fluorescent image and fluorescent intensity in the SSCT fluorescent image. For example, SSCT cell death may be determined or quantified, for each dataset, from:
a ratio of luminescence and fluorescent area in the SSCT fluorescent image, or
a ratio of luminescence and fluorescent intensity in the SSCT fluorescent image, or
a ratio of luminescence and a mean of fluorescent intensity and fluorescent area in the SSCT fluorescent image.

ICT cell death may be determined or quantified, for each dataset, from the luminescence captured from the suitably transfected ICT, and one or more of fluorescent area in the ICT fluorescent image and fluorescent intensity in the ICT fluorescent image. For example, ICT cell death may be determined or quantified, for each dataset, from:
a ratio of luminescence and fluorescent area in the ICT fluorescent image, or
a ratio of luminescence and fluorescent intensity in the ICT fluorescent image, or
a ratio of luminescence and a mean of fluorescent intensity and fluorescent area in the ICT fluorescent image.

The luminescent cell-death marker emits luminescence when the cell wall is breached (e.g. apoptosis, lysis, cell death) by reaction with one or more reagents in the cell culture medium. The luminescent marker may be introduced, e.g. by transfection or transduction of an expression vector, into the cell type (one or more of TCO, SCT, SSCT (where present) ICT (where present)) as a gene that continually expresses the luminescent cell-death marker.

The luminescent cell-death marker may contain a HiBiT tag (SEQ ID: 1). The HiBiT tag binds with a LgBiT polypeptide in the cell culture medium and there is a release of luminescence upon binding and reaction with a detection reagent in the cell culture medium (e.g. Nano-Glo® Endurazine™ or Vivazine™ Live cell substrate).

Preferably, the luminescent cell-death marker contains a HaloTag-HiBiT fusion protein (SEQ ID: 4) that is a fusion protein comprising a HaloTag polypeptide (SEQ ID: 2) and the HiBiT tag (SEQ ID: 1). A function of the HaloTag polypeptide is to act as a stabilizing fusion protein e.g. reducing transmembrane leakage and breakdown of the smaller HiBiT part. Additionally, the HaloTag polypeptide may be used as a ligand for intracellular detection/localization of the HaloTag-HiBiT protein (e.g. quantify HaloTag-HiBiT expression for normalization). The HaloTag polypeptide and HiBiT peptide tag may be joined by a linker peptide (HH linker peptide) (e.g. SEQ ID: 3).

Examples of expression vectors for HiBiT tag or HaloTag-HiBiT fusion protein include be HaloTag-HiBiT-LentiB3 Transfer Vector CS3055A34 (Promega), or CAG/HaloTag-HiBiT/BlastR Vector CS1956B17 (Promega)

The cell type (one or more of TCO, SCT, SSCT (where present), ICT (where present)) may be labelled with the live-cell fluorescent label having the first (TCO), second (SCT), SSCT (SSCT where present), or ICT (ICT where present) emission/excitation profile and with the luminescent cell-death marker. The live-cell fluorescent label and the luminescent cell-death marker may be stably expressed within the cell type by translation of a genetic construct encoding a fluorescent-luminescent fusion protein comprising the live-cell fluorescent label and the luminescent cell-death marker.

The live-cell fluorescent label may be any protein that is fluorescent. It is fluorescently active at least within the cell. The live-cell fluorescent label may be a fluorescent protein such as Red fluorescent protein (RFP) (SEQ ID: 5), Green fluorescent protein (GFP) (SEQ ID: 6), or mCherry (SEQ ID: 7).

The luminescent cell-death marker emits luminescence when the cell wall is breached (e.g. apoptosis, lysis, cell death) by reaction with one or more reagents in the cell culture medium. The luminescent cell-death marker may contain a HiBiT tag (SEQ ID: 1); it may contain the HaloTag-HiBiT fusion protein (SEQ ID: 4). The HaloTag-HiBiT fusion protein contains the HaloTag polypeptide (SEQ ID: 2) and the HiBiT tag (SEQ ID: 1) joined by a linker peptide (e.g. SEQ ID: 3).

The live-cell fluorescent label and the luminescent cell-death marker may be joined by a self-cleaving peptide, that is cleaved within the cell, thereby releasing within the cell the live-cell fluorescent label and the luminescent cell-death marker. The self-cleaving peptide may be T2A (SEQ ID: 8).

Provided is a fluorescent-luminescent fusion protein comprising the live-cell fluorescent label, the luminescent cell-death marker linked by the self-cleaving peptide.

Provided is a genetic construct encoding the fluorescent-luminescent fusion protein. The genetic construct can be cloned into a vector (e.g. expression vector, replication vector).

By “encoding” is meant that a nucleic acid sequence or part(s) thereof corresponds, by virtue of the genetic code of an organism in question, to a particular amino acid sequence, e.g., the amino acid sequence of a desired polypeptide or protein. By means of example, nucleic acids “encoding” a particular polypeptide or protein may encompass genomic, hnRNA, pre-mRNA, mRNA, cDNA, recombinant or synthetic nucleic acids.

The genetic construct described herein comprises, preferably in that order, a nucleotide sequence encoding a live-cell fluorescent label, a nucleotide sequence encoding a self-cleaving peptide such as a T2A peptide, and a nucleotide sequence encoding a luminescent cell-death marker.

The genetic construct may further comprise a promoter operably linked to the nucleotide sequences encoding the fluorescent-luminescent fusion protein. The term ‘operably linked’ as used herein refers to the arrangement of various nucleic acid molecule elements relative to each such that the elements are functionally connected and are able to interact with each other. Such elements may include, without limitation, a promoter and/or an enhancer, a transcription terminator, and a coding sequence of a gene of interest to be expressed. The nucleic acid sequence elements, when properly oriented or operably linked, act together to modulate the activity of one another, and ultimately may affect the level of expression of the fluorescent-luminescent fusion protein. By modulate is meant increasing, decreasing, or maintaining the level of activity of a particular element. The position of each element relative to other elements may be expressed in terms of the 5′ terminus and the 3′ terminus of each element, and the distance between any particular elements may be referenced by the number of intervening nucleotides, or base pairs, between the elements. As understood by the skilled person, operably linked implies functional activity, and is not necessarily related to a natural positional link.

Promoters envisaged in the context of the present invention will be determined by its ability to direct expression in the TCO of interest as can be readily understood by the skilled person. Other sequences may be incorporated in the genetic construct, more particularly the inclusion of sequences which further increase or stabilize the expression of the expressed products (e.g. introns and/or a transcription termination sequence).

In particular embodiments, the expression further comprise a transcription termination sequence. Any polyadenylation signal that directs the synthesis of a polyA tail is useful in the expression cassette described herein, examples of those are well known to one of skill in the art. The genetic construct envisaged herein may be used as such, or typically, they may be part of (i.e. introduced into) a vector.

Provided is an expression vector containing the genetic construct. The expression vector is configured for expression of the genes within a cell (e.g. TCO) transfected or transduced with the expression vector.

The vectors disclosed herein may further include an origin of replication that is required for maintenance and/or replication in a specific cell type. One example is when a vector is required to be maintained in a host cell as an episomal genetic element (e.g. plasmid or cosmid molecule). Exemplary origins of replication include, but are not limited to the f1-ori, colE1 ori, and Gram+ bacteria origins of replication.

The vectors taught herein may further contain restriction sites of various types for linearization or fragmentation.

Numerous vectors are known to practitioners skilled in the art and any such vector may be used. Selection of an appropriate vector is a matter of choice. The vector may be a non-viral or viral vector. Non-viral vectors include but are not limited to plasmids, cationic lipids, liposomes, nanoparticles, PEG, PEI, etc. Viral vectors are derived from viruses including but not limited to: retrovirus, lentivirus, adeno-associated virus, adenovirus, herpesvirus, hepatitis virus or the like.

The expression vector may be pLenti-mCherry-T2A-HaloTag-HiBiT transfer vector, pLenti-mCherry-RFP-HaloTag-HiBiT transfer vector, pLenti-GFP-T2A-HaloTag-HiBiT transfer vector.

Methods for transforming a cell type with a genetic construct or a vector as taught herein above are well known to a skilled person. For example, electroporation, chemical (such as calcium chloride- or lithium acetate-based) transformation methods, microparticles bombardment, glass beads, or viral- or Agrobacterium tumefaciens-mediated transformation methods as known in the art can be used.

The genetic construct or vectors disclosed herein may either be integrated into the nuclear genome of the cell type or they may be maintained in some form (such as a plasmid) extrachromosomally. A stably transformed host cell is one in which the exogenous nucleic acid has become integrated into a chromosome so that it is inherited by daughter cells through chromosome replication.

HiBiT tag (SEQ ID: 1):
VSGWRLFKKI S
HaloTag polypeptide (SEQ ID: 2):
MAEIGTGFPF DPHYVEVLGE RMHYVDVGPR DGTPVLFLHG
NPTSSYVWRN IIPHVAPTHR CIAPDLIGMG KSDKPDLGYF
FDDHVRFMDA FIEALGLEEV VLVIHDWGSA LGFHWAKRNP
ERVKGIAFME FIRPIPTWDE WPEFARETFQ AFRTTDVGRK
LIIDQNVFIE GTLPMGVVRP LTEVEMDHYR EPFLNPVDRE
PLWRFPNELP IAGEPANIVA LVEEYMDWLH QSPVPKLLFW
GTPGVLIPPA EAARLAKSLP NCKAVDIGPG LNLLQEDNPD
LIGSEIARWL STLEISG
HH linker peptide (SEQ ID: 3):
VSQGSSGGGG SGGGGSSG
HaloTag- HiBiT fusion protein (SEQ ID: 4):
MAEIGTGFPF DPHYVEVLGE RMHYVDVGPR DGTPVLFLHG
NPTSSYVWRN IIPHVAPTHR CIAPDLIGMG KSDKPDLGYF
FDDHVRFMDA FIEALGLEEV VLVIHDWGSA LGFHWAKRNP
ERVKGIAFME FIRPIPTWDE WPEFARETFQ AFRTTDVGRK
LIIDQNVFIE GTLPMGVVRP LTEVEMDHYR EPFLNPVDRE
PLWRFPNELP IAGEPANIVA LVEEYMDWLH QSPVPKLLFW
GTPGVLIPPA EAARLAKSLP NCKAVDIGPG LNLLQEDNPD
LIGSEIARWL STLEISGVSQ GSSGGGGSGG GGSSGVSGWR
LFKKIS
Red fluorescent protein (SEQ ID: 5):
MRSSKNVIKE FMRFKVRMEG TVNGHEFEIE GEGEGRPYEG
HNTVKLKVTK GGPLPFAWDI LSPQFQYGSK VYVKHPADIP
DYKKLSFPEG FKWERVMNFE DGGVVTVTQD SSLQDGCFIY
KVKFIGVNFP SDGPVMQKKT MGWEASTERL YPRDGVLKGE
IHKALKLKDG GHYLVEFKSI YMAKKPVQLP GYYYVDSKLD
ITSHNEDYTI VEQYERTEGR HHLFL
Green fluorescent protein (SEQ ID: 6):
MSKGEELFTG VVPILVELDG DVNGHKFSVS GEGEGDATYG
KLTLKFICTT GKLPVPWPTL VTTFSYGVQC FSRYPDHMKQ
HDFFKSAMPE GYVQERTIFF KDDGNYKTRA EVKFEGDTLV
NRIELKGIDF KEDGNILGHK LEYNYNSHNV YIMADKQKNG
IKVNFKIRHN IEDGSVQLAD HYQQNTPIGD GPVLLPDNHY
LSTQSALSKD PNEKRDHMVL LEFVTAAGIT HGMDELYK
mCherry (SEQ ID: 7):
MVSKGEEDNM AIIKEFMRFK VHMEGSVNGH EFEIEGEGEG
RPYEGTQTAK LKVTKGGPLP FAWDILSPQF MYGSKAYVKH
PADIPDYLKL SFPEGFKWER VMNFEDGGVV TVTQDSSLQD
GEFIYKVKLR GTNFPSDGPV MQKKTMGWEA SSERMYPEDG
ALKGEIKQRL KLKDGGHYDA EVKTTYKAKK PVQLPGAYNV
NIKLDITSHN EDYTIVEQYE RAEGRHSTGG MDELYK
T2A self-cleaving peptide (SEQ ID: 8):
EGRGSLLTC GDVEENPGP

A protein mention herein may be a variant of a protein. The term “variant”, when used in connection to a protein, for example as in “a variant of protein X”, refers to a protein that is altered in its sequence compared to protein X, but that retains the activity of protein X (i.e. a functional variant). Preferably, such variant would show at least 80%, more preferably at least 85%, even more preferably at least 90%, and yet more preferably at least 95% such as at least 96%, at least 97%, at least 98% or at least 99% sequence identity to the reference protein, preferably calculated over the entire length of the sequence. The sequence changes may be naturally occurring, for example, due to the degeneracy of the genetic code, or may be introduced artificially, for example by targeted mutagenesis of the respective sequence. Such techniques are well known to the skilled person.

As used herein, the terms “identity” and “identical” and the like are used interchangeably with the terms “homology” and “homologues” and the like herein and refer to the sequence similarity between two polymeric molecules, e.g., between two nucleic acid molecules or polypeptides. Methods for comparing sequences and determining sequence identity are well known in the art. By means of example, percentage of sequence identity refers to a percentage of identical nucleic acids or amino acids between two sequences after alignment of these sequences. Alignments and percentages of identity can be performed and calculated with various different programs and algorithms known in the art. Preferred alignment algorithms include BLAST (Altschul, 1990; available for instance at the NCBI website) and Clustal (reviewed in Chenna, 2003; available for instance at the EBI website). Preferably, BLAST is used to calculate the percentage of identity between two sequences, such as the “Blast 2 sequences” algorithm described by Tatusova and Madden 1999 (FEMS Microbiol Lett 174:247-250), for example using the published default settings or other suitable settings (such as, e.g., for the BLASTN algorithm: cost to open a gap=5, cost to extend a gap=2, penalty for a mismatch=−2, reward for a match=1, gap x_dropoff=50, expectation value=10.0, word size=28; or for the BLASTP algorithm: matrix=Blosum62, cost to open a gap=11, cost to extend a gap=1, expectation value=10.0, word size=3).e

A method described herein may be a computer implemented method. The method may be performed using a standard computer system such as an Intel Architecture IA-32 based computer system 2, and implemented as programming instructions of one or more software modules stored on non-volatile (e.g., hard disk or solid-state drive) storage associated with the corresponding computer system. However, it will be apparent that at least some of the steps of any of the described processes could alternatively be implemented, either in part or in its entirety, as one or more dedicated hardware components, such as gate configuration data for one or more field programmable gate arrays (FPGAs), or as application-specific integrated circuits (ASICs), for example.

Provided is a computing device or system configured for performing a method as described herein.

Provided is a device program or computer program product having instructions which when executed by a computing device or system cause the computing device or system to perform a method as described herein.

Provided is a computer readable medium having stored thereon instructions which when executed by a computing device or system cause the computing device or system to perform a method as described herein.

Provided is a data stream representative of a computer program or computer program product having instructions which when executed by a computing device or system cause the computing device or system to perform a method as described herein.

Further provided is a system comprising a fluorescence microscope and a processor, wherein
the fluorescence microscope is configured to acquire a dataset comprising:
   a first fluorescent image from the fluorescent live-cell marker having the first emission/excitation profile, and
   a second fluorescent image from the fluorescent live-cell marker having the second emission/excitation profile, and
the processor is configured to:
   receive at least one dataset, and to identify for each dataset, a stroma (512) for the TCO (520), wherein:
      a stroma (512) comprises at least one cluster (514, a to d);
      a cluster (514, a to d) comprises a plurality of cells of the SCT (510, a to b), and each
      SCT (510, a to b) cell in the cluster (514, a to d) directly contacts the TCO (520) or indirectly contacts the TCO (520) via one or more other SCTs (510, a to b) cells,
   determine the status of the sample from at least one parameter of the stroma (512).

Further provided is a system comprising an autostainer, a fluorescence microscope and a processor, wherein
the autostainer is configured to label a target cellular object, TCO (520) with a fluorescent live-cell marker having a first emission/excitation profile, and to label a SCT (510, a to b) with a fluorescent live-cell marker having a second emission/excitation profile different from the first emission/excitation profile;
the fluorescence microscope is configured to acquire a dataset comprising:
   a first fluorescent image from the fluorescent live-cell marker having the first emission/excitation profile, and
   a second fluorescent image from the fluorescent live-cell marker having the second emission/excitation profile, and
the processor is configured to:
   receive at least one dataset, and to identify for each dataset, a stroma (512) for the TCO (520), wherein:
      a stroma (512) comprises at least one cluster (514, a to d);
      a cluster (514, a to d) comprises a plurality of cells of the SCT (510, a to b), and each
      SCT (510, a to b) cell in the cluster (514, a to d) directly contacts the TCO (520) or indirectly contacts the TCO (520) via one or more other SCTs (510, a to b) cells,
   determine the status of the sample from at least one parameter of the stroma (512).

### Example

A co-culture was prepared of patient-derived pancreatic tumor organoids (TCO) and cancer associated fibroblast (SCT), wherein the TCO and the SCT were fluorescently labelled with the first and second fluorescent label respectively. First and second fluorescent images were recorded and the status of the sample was determined with and without contacting the sample with Nintedanib, TGFB or FGF2. Nintedanib is a known anti-fibrotic drug that inhibits fibroblast proliferation and motility. TGFB and FGF2 are growth factors that can stimulate fibroblast proliferation. The results are shown in FIGS. 5 to 12.

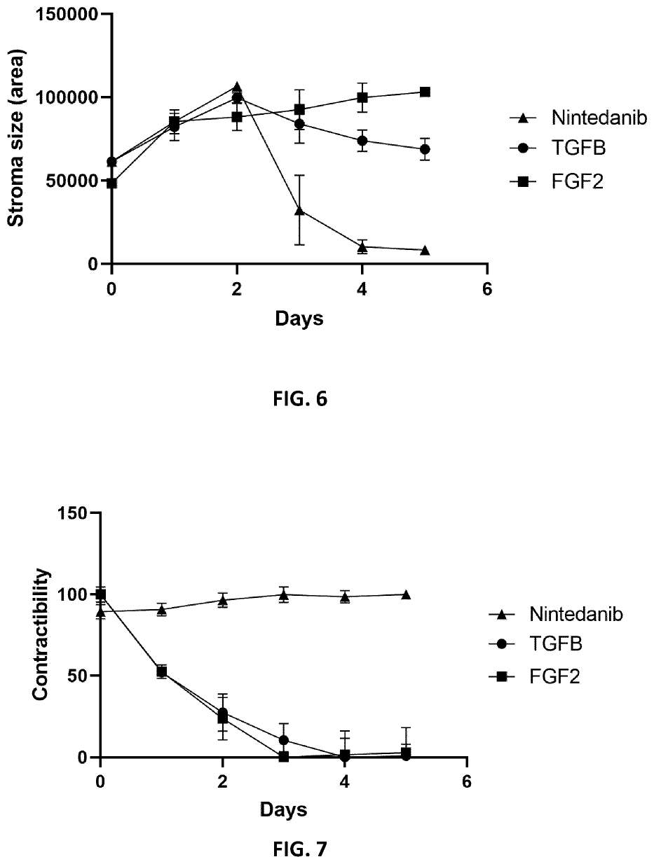

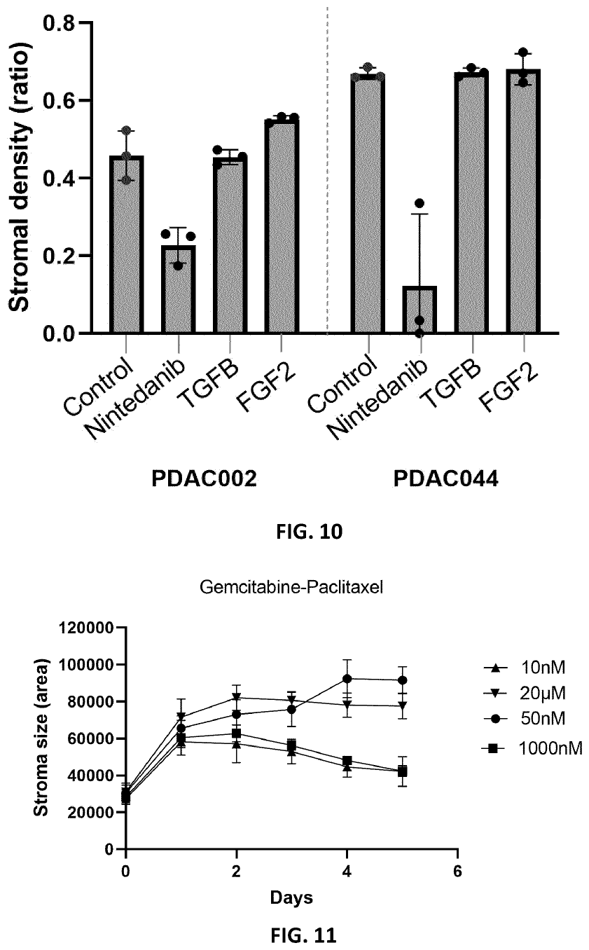

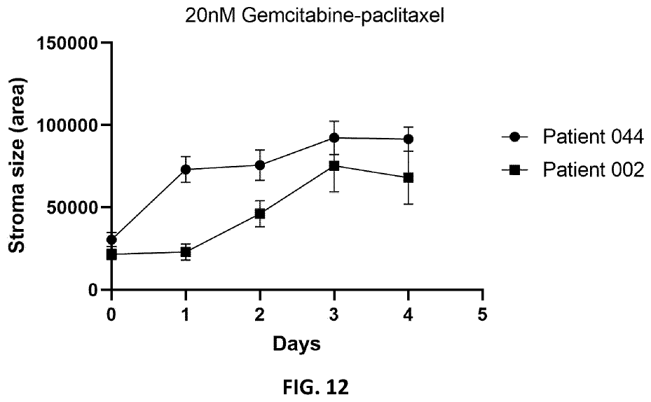

The stroma growth rate (FIG. 5) and stroma size (FIG. 6) were each inhibited by nintedanib and stimulated the strongest by FGF2. In addition, motility was inhibited by nintedanib as shown by the lack of contractility (FIGS. 7 and 8), reduced stromal size ratio (FIG. 9) and stromal density of the micro-tumor (FIG. 10). Therefore, nintedanib inhibited the micro-tumor formation driven by activated fibroblasts. Furthermore, stimulation by TGFB and FGF2 only had marginal effects on stromal density compared to the control (FIG. 10) indicating that the fibroblasts already have a high state of activation in the co-cultures, potentially driven by the bidirectional communication between the fibroblasts and cancer organoids. Finally, treatment with standard of care gemcitabine-paclitaxel inhibited stromal size in a patient-depended manner (FIGS. 11 and 12).

1. A method for determining a status of a sample comprising a co-culture comprising a target cellular object, TCO (520), and one or more stroma-forming cell types, SCT (510, a to b), wherein:
the TCO (520) has been labelled with a fluorescent live-cell marker having a first emission/excitation profile, and
the SCT (510, a to b) has been labelled with a fluorescent live-cell marker having a second emission/excitation profile different from the first emission/excitation profile, the method comprising the steps:
capturing, during an acquisition event using a microscope, a dataset comprising:
a first fluorescent image from the fluorescent live-cell marker having the first emission/excitation profile, and
a second fluorescent image from the fluorescent live-cell marker having the second emission/excitation profile, and
wherein:
at least one dataset is captured,
for each dataset, a stroma (512) is identified for the TCO (520), wherein:
a stroma (512) comprises at least one cluster (514, a to d);
a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells,
the status of the sample is determined from:
at least one parameter of the stroma (512), wherein at least one parameter of the stroma (512) comprises one or more of:
stroma size, stroma size ratio, stroma density, stroma-free SCT velocity, contractility (Table 1 (Parameters 1 to 5)),
and
a presence or absence of an identified stroma, and/or
a value(s) of the at least one parameter of the stroma of the identified stroma, and/or
a comparison of the at least one parameter of the stroma of the identified stroma with a comparable reference, and/or
an evolution of the at least one parameter of the stroma over time of the identified stroma.

2. A method for determining an effect of a potential active agent on a sample comprising a co-culture comprising a target cellular object, TCO (520), and one or more stroma-forming cell types, SCT (510, a to b), wherein:
the TCO (520) has been labelled with a fluorescent live-cell marker having a first emission/excitation profile, and
the stroma-forming cell types, SCT (510, a to b) has been labelled with a fluorescent live-cell marker having a second emission/excitation profile different from the first emission/excitation profile,
the method comprising the steps:
capturing, during an acquisition event using a microscope, a dataset comprising:
a first fluorescent image from the fluorescent live-cell marker having the first emission/excitation profile, and
a second fluorescent image from the fluorescent live-cell marker having the second emission/excitation profile, and
wherein
a plurality of datasets is captured, of which at least one test dataset is captured for a sample contacted with the potential active agent and one at least one control dataset is captured for a sample not contacted with the potential active agent,
for each test dataset and for each control dataset, a stroma (512) is identified for the TCO (520), wherein:
the stroma (512) comprises at least one cluster (514, a to d);
a cluster (514, a to d) comprises a plurality of cells of the SCT (510, a to b), and each SCT (510, a to b) cell in the cluster (514, a to d) directly contacts the TCO (520) or indirectly contacts the TCO (520) via one or more other SCTs (510, a to b) cells,
the status of the test sample and the status control sample is determined from at least one parameter of the respective stromas (512), wherein the at least one parameter of each stroma (512) comprises one or more of:
stroma size, stroma size ratio, stroma density, stroma-free SCT velocity, contractility (Table 1 (Parameters 1 to 5)),
determining from a difference between the status of the test sample and the status control sample an effect of the potential active agent.

3. The method according to claim 1 or 2, wherein the status of the sample is further determined from at least one other measurable parameter of Table 2 (Parameters 6 to 8).

4. The method according to any one of claims 1 to 3, wherein the sample co-culture further comprises a stroma-supporting cell type (SSCT) (530, a,b), different from the TCO (520) and SCT (510, a to b) cells, wherein:
the SSCT (530, a,b) has been labelled with a fluorescent live-cell marker having an SSCT emission/excitation profile different from the first and second emission/excitation profiles,
the dataset further comprises an SSCT fluorescent image (503) from the fluorescent live-cell marker having the SSCT emission/excitation profile,
wherein the status of the sample is further determined from
at least one parameter of the SSCT, wherein the at least one parameter of the SSCT comprises one or more of Parameter 9, Parameter 10, Parameter 11, Parameter 12 of Table 3,
and
a presence or absence of a SSCT, and/or
a value(s) of the at least one parameter of the SSCT, and/or
a comparison of the at least one parameter of the SSCT with a comparable reference, and/or
an evolution of the at least one parameter of the SSCT over time.

5. The method according to claim 4, wherein the SSCT is endothelial.

6. The method according to any one of claims 1 to 5, wherein the sample co-culture further comprises an immune cell type (ICT) (540, a to d), different from the TCO (520) and SCTs (510, a to b) cells, wherein:
the ICT (540, a to d) has been labelled with a fluorescent live-cell marker having an ICT emission/excitation profile different from the first and second emission/excitation profiles,
the dataset further comprises an ICT fluorescent image (503) from the fluorescent live-cell marker having the ICT emission/excitation profile,
wherein the status of the sample is further determined from
at least one parameter of the ICT of Table 4 (Parameters 13 to 20), wherein the at least one parameter of the ICT comprises one or more of Parameters 13 to 20 of Table 3, and
a presence or absence of an ICT, and/or
a value(s) of the at least one parameter of the ICT, and/or
a comparison of the at least one parameter of the ICT with a comparable reference, and/or
an evolution of the at least one parameter of the ICT over time.

7. The method according to any one of claim 6, wherein the ICT (540, a to d) is
immune cell(s), such as peripheral blood mononuclear cell (PBMC), natural killer cell, cytotoxic T-cell, macrophages, or
genetically engineered immune cell(s) such as Chimeric antigen receptor T (CAR-T), Chimeric Antigen Receptor-Engineered Natural Killer (CAR NK).

8. The method according to any one of claims 1 to 7, wherein the sample co-culture contains 1 to 10% (w/v) basement membrane matrix.

9. The method according to any one of claims 1 to 8, wherein:
the TCO (520) is a patient-derived organoid or cancer cell line derived spheroid, and
the SCT (510, a to b) is a fibroblast or cancer activated fibroblast (CAF).

10. The method according to any one of claims 1 to 9, wherein the sample comprises multiple TCOs (520), and
at least some of TCOs (520) each has a stroma, and/or
at least some of TCOs (520) share a stroma.

11. A computing device or system configured for performing a method according to any one of claims 1 to 10.

12. A program or computer program product having instructions which when executed by a computing device or system cause the computing device or system to perform a method according to any one of claims 1 to 10.

13. A computer readable medium having stored thereon instructions which when executed by a computing device or system cause the computing device or system to perform a method according to any one of claims 1 to 10.

14. A data stream representative of a computer program or computer program product having instructions which when executed by a computing device or system cause the computing device or system to perform a method according to any one of claims 1 to 10.


SEQUENCE LISTING (8 sequences)

SEQ ID NO: 1 - protein, 11 aa, synthetic construct
  REGION 1..11: note = HiBiT tag
VSGWRLFKKIS

SEQ ID NO: 2 - protein, 297 aa, synthetic construct
  REGION 1..297: note = HaloTag polypeptide
MAEIGTGFPFDPHYVEVLGERMHYVDVGPRDGTPVLFLHGNPTSSYVWRNIIPHVAPTHRCIAPDLIGMGKSDKPDLGYFFDDHVRFMDAFIEALGLEEVVLVIHDWGSALGFHWAKRNPERVKGIAFMEFIRPIPTWDEWPEFARETFQAFRTTDVGRKLIIDQNVFIEGTLPMGVVRPLTEVEMDHYREPFLNPVDREPLWRFPNELPIAGEPANIVALVEEYMDWLHQSPVPKLLFWGTPGVLIPPAEAARLAKSLPNCKAVDIGPGLNLLQEDNPDLIGSEIARWLSTLEISG

SEQ ID NO: 3 - protein, 18 aa, synthetic construct
  REGION 1..18: note = HH linker peptide
VSQGSSGGGGSGGGGSSG

SEQ ID NO: 4 - protein, 326 aa, synthetic construct
  REGION 1..326: note = HaloTag- HiBiT fusion protein
MAEIGTGFPFDPHYVEVLGERMHYVDVGPRDGTPVLFLHGNPTSSYVWRNIIPHVAPTHRCIAPDLIGMGKSDKPDLGYFFDDHVRFMDAFIEALGLEEVVLVIHDWGSALGFHWAKRNPERVKGIAFMEFIRPIPTWDEWPEFARETFQAFRTTDVGRKLIIDQNVFIEGTLPMGVVRPLTEVEMDHYREPFLNPVDREPLWRFPNELPIAGEPANIVALVEEYMDWLHQSPVPKLLFWGTPGVLIPPAEAARLAKSLPNCKAVDIGPGLNLLQEDNPDLIGSEIARWLSTLEISGVSQGSSGGGGSGGGGSSGVSGWRLFKKIS

SEQ ID NO: 5 - protein, 225 aa, synthetic construct
  REGION 1..225: note = Red fluorescent protein
MRSSKNVIKEFMRFKVRMEGTVNGHEFEIEGEGEGRPYEGHNTVKLKVTKGGPLPFAWDILSPQFQYGSKVYVKHPADIPDYKKLSFPEGFKWERVMNFEDGGVVTVTQDSSLQDGCFIYKVKFIGVNFPSDGPVMQKKTMGWEASTERLYPRDGVLKGEIHKALKLKDGGHYLVEFKSIYMAKKPVQLPGYYYVDSKLDITSHNEDYTIVEQYERTEGRHHLFL

SEQ ID NO: 6 - protein, 238 aa, synthetic construct
  REGION 1..238: note = Green fluorescent protein
MSKGEELFTGVVPILVELDGDVNGHKFSVSGEGEGDATYGKLTLKFICTTGKLPVPWPTLVTTFSYGVQCFSRYPDHMKQHDFFKSAMPEGYVQERTIFFKDDGNYKTRAEVKFEGDTLVNRIELKGIDFKEDGNILGHKLEYNYNSHNVYIMADKQKNGIKVNFKIRHNIEDGSVQLADHYQQNTPIGDGPVLLPDNHYLSTQSALSKDPNEKRDHMVLLEFVTAAGITHGMDELYK

SEQ ID NO: 7 - protein, 236 aa, synthetic construct
  REGION 1..236: note = mCherry
MVSKGEEDNMAIIKEFMRFKVHMEGSVNGHEFEIEGEGEGRPYEGTQTAKLKVTKGGPLPFAWDILSPQFMYGSKAYVKHPADIPDYLKLSFPEGFKWERVMNFEDGGVVTVTQDSSLQDGEFIYKVKLRGTNFPSDGPVMQKKTMGWEASSERMYPEDGALKGEIKQRLKLKDGGHYDAEVKTTYKAKKPVQLPGAYNVNIKLDITSHNEDYTIVEQYERAEGRHSTGGMDELYK

SEQ ID NO: 8 - protein, 18 aa, synthetic construct
  REGION 1..18: note = T2A self-cleaving peptide
EGRGSLLTCGDVEENPGP